(19) United States
(12) Patent Application Publication
(10) Pub. No.: US 2010/0161473 A1
(43) Pub. Date: Jun. 24, 2010

(54) CONFIRMATION OF USER ACTION REQUEST

(75) Inventors: Sean Larsgard, South Jordan, UT (US); Jason Anderson, Farmington, UT (US); Brad H. Jones, South Jordan, UT (US)

Correspondence Address: Workman Nydegger;1000 Eagle Gate Tower, 60 East South Temple, Salt Lake City, UT, 84111, US

(73) Assignee: Trading2, LLC, Farmington, UT (US)

(21) Appl. No.: 12/338,711

(22) Filed: Dec. 18, 2008

(51) Int. Cl. G06Q 40/00; G06F 3/01; G06F 15/16; G09G 5/00; G06F 3/033

(52) U.S. Cl. 705/37; 715/733; 709/203; 345/156; 345/161

(57) ABSTRACT

A controller confirms a user action request. The controller includes a housing body having a modified H-shape configuration. The housing body has hand grips at longitudinal ends to provide support for the user's hands to hold the controller. A command button is arranged on the housing body. The command button is configured to initiate user action requests to a computer system. A confirmation button is arranged on the housing body. When the confirmation button is pressed simultaneously with the command button, the user action request is confirmed and relayed through the computer system to a third party system.

### CROSS-REFERENCE TO RELATED APPLICATIONS

Not Applicable.

### BACKGROUND OF THE INVENTION

1. The Field of the Invention

This invention relates to systems, components and apparatuses relating to trading and bidding platforms, and more specifically to systems for confirming user action requests in trading and bidding platforms.

2. Background and Relevant Art

Controllers have been used for TV game machines in the home. One controller included a cross-shaped key button provided on an operation surface of the housing. This controller provided four different instructions for the game machine by only moving a thumb placed on the key button. The instructions were initiated by moving the thumb upward, downward, to the left and to the right.

With more complicated gaming systems, the number of operation switches has been increased. When more operation switches are included in the controller, some conditions have been incorporated into the system to provide good controllability. For example, the controllers have been designed so that a user does not need to move his or her hand to operate the various buttons. The switches have been designed to be depressed with minimum finger movement. The direction of finger movement has a natural design along the joint movement of the user's finger. When the index finger or middle finger is used, the controller has been designed to allow the user to move the finger in a narrower range with respect to the thumb. The controller has also been designed to be held by both hands.

Various features and components have been added to the gaming controllers. Most of the features assist a user to act quickly and respond to the graphical interface. The controllers, however, do not provide a system for confirming a user's action request.

### BRIEF SUMMARY OF THE INVENTION

In one aspect of the invention, a controller confirms a user action request. The controller includes a housing body having a modified H-shape configuration. The housing body has hand grips at longitudinal ends to provide support for the user's hands to hold the controller. A command button is arranged on the housing body. The command button is configured to initiate user action requests to a computer system. A confirmation button is arranged on the housing body. When the confirmation button is pressed simultaneously with the command button, the user action request is confirmed and relayed through the computer system to a third party system.

In another aspect of the invention, a system for confirming a user action request is provided. A computer system has a user interface connected to the computer system to provide additional user input to the computer system and a display device to display a user interface for software programs. A controller is attached to the computer system through a connecting device. The controller is configured to relay user action requests through the computer system to a third party system. The controller includes a command button and a confirmation button. The confirmation button is pressed simultaneously with the command button to confirm a desired user action request and relay the request through the computer to the third party system.

In a further aspect of the invention, a method of confirming a user action request is provided through a controller connected to a computer system. The method includes triggering an action on the controller by pressing a button. A confirmation request is executed by simultaneously pressing and holding a confirmation button while pressing another button to initiate a desired action request. The software determines whether the buttons were pressed at the same time. If both buttons are not pressed simultaneously, the computer system does not execute the command. If the buttons are pressed at the same time, the computer system executes the command.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which.

FIG. 1 illustrates a system for confirming a user action request;

FIG. 2 is a top view of a controller in accordance with the various embodiments of the invention;

FIG. 3 is an isometric view of the controller of FIG. 2; and

FIG. 4 illustrates a method of confirming a user action request in accordance with the various embodiments of the invention.

### DETAILED DESCRIPTION OF THE VARIOUS EMBODIMENTS

The present invention extends to systems, components and apparatuses relating to trading and bidding platforms, and more specifically to systems for confirming user action requests in trading and bidding platforms. For example, the systems and apparatuses are designed to facilitate quicker reaction times from a user to send an action request to a third party system, such as a broker system, trading platform, bidding system, or an auction system. The user can be interfaced to a computer through a wired or wireless handheld control device.

A controller is configured to relay user action requests to the user's computer and on to a broker system, trading platform, bidding system, or an auction system. The user action request is confirmed through a sequence of triggering events that the user performs. The controller can include request confirmation and other controls. For example, the controller can be configured to provide user-intuitive buttons and a digital direction control joystick to control navigation within various interfaces. The interfaces can include a multifunctional order execution sequence. The controller, for instance, can: (a) enable advanced functionality while providing freedom from the standard “mouse and keyboard” trade order execution methods and (b) increase command execution speed through a gaming-like handheld user controller.

Throughout the discussion of this system, the term “user” may be used to describe students, employees, content providers, employers, brokers, or other who are accessing the enterprise system using a computer. The computer may be any specific of general computer system that is equipped to receive, send, and process a user's action request. The computer may be, for example, a personal computer, or any other computing machine. A suitable computer system may include components such as a modem, monitor, keyboard, mouse, system software including support for TCP/IP communication, and other various types of software. While using the system, more than one user may connect to the enterprise system using the same computer.

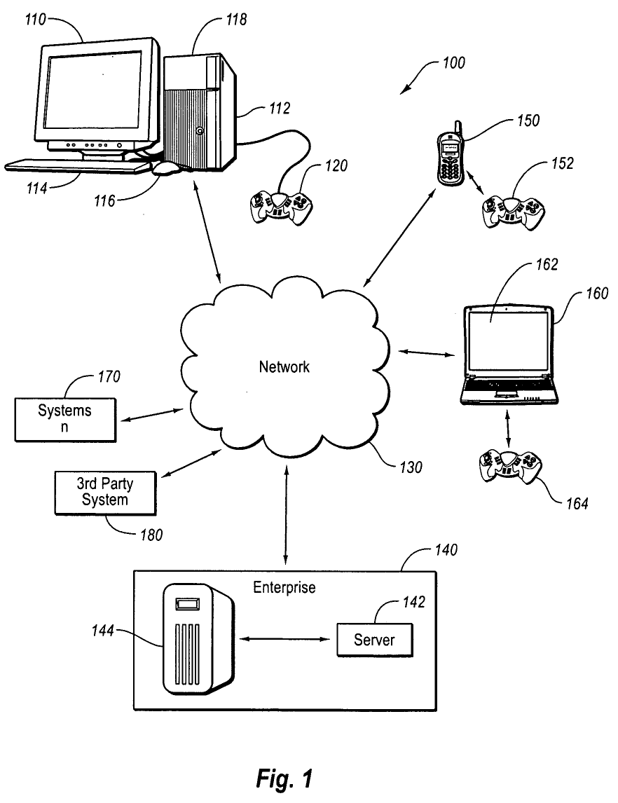

FIG. 1 illustrates a system 100 for confirming user action requests. The system 100 includes a computer system 110 having a computer 112, such as a desktop, laptop or handheld portable computer. A user interface, such as a keyboard 114 and/or a mouse 116 can be connected to the computer 112 to provide additional user input to the computer system 110. The computer also includes a display device 118, such as a monitor, screen, or projection screen to display the user interface for software programs. A controller 120 is attached to the computer system 110 through a wireless connection, such as Wi-Fi, Bluetooth technology, or other wireless technology or a hard wire connection, such as a USB cable, parallel port, or other known connecting devices used to connect a user interface to a computer system.

The computer system 110 communicates through a local or global computer network 130, such as any local or global network, including a LAN, WAN, wireless network, Internet connection, World Wide Web, or other similar networks. The computer system 110 communicates through the network to an enterprise system 140. The enterprise system 140 includes a server 142 that is connected to a database 144.

Other systems 170 can be connected to the enterprise system 140 through the network 130. The systems 170 are represented as “systems n” to include any defined amount of devices connected to the network 130. The enterprise system 140 can be modified to match the users' needs, for example, by adding more bandwidth, servers, and/or database capacity. Each of the other systems 170 includes similar components as those defined in the computer systems 110, 150, and 160, which may be connected to the enterprise system 140 in a similar manner. For example, the computer may be a handheld device 150, such as a PDA, gaming device, smart phone, UltraNet Multi-service Director (UMD) products, and other known handheld products with internet connection capabilities. The handheld device 150 can be connected to the enterprise system 140 through a data service on the handheld device 150. A controller 152 can be connected to the handheld device 150 through a wireless connection as discussed above. Alternatively, the controller 152 can also be built into the handheld device 150.

The computer system can be a desktop computer 160 including a display device 162, such as a monitor, and a controller 164. The controller 164 can be attached to the desktop computer 160 through a wireless connection as discussed above.

Numerous devices 170 with various configurations may be attached to the enterprise system 140 through the network 130. The devices 170 can include desktop computers, laptops, handheld devices, or other known computing devices for executing a user generated action request.

Software and drivers are installed on a user's computer from the enterprise system 140. The user can install the software and drivers from an installation disc included with the controller. To install the software, for example, the user can select from a dropdown list in the installation wizard a desired trading platform or broker system to be used. Alternatively, the software and drivers can be preloaded onto the controller. The user can customize additional features as desired to optimize the controller to meet personal preferences.

The computer systems can communicate with a third party system 180, which can include a broker system, trading platform, an auction system, a bidding platform or the like. The third party system 180, for instance, can be a brokerage Web site, such as eTrade, Scottrade, Firstrade, Ameritrade, and similar security investing systems, auction platforms, such as eBay, or bidding platforms, such as Craig's List.

The user can run the trading platform or broker system software programs to watch and analyze portfolios or bidding items. The controller is held by the user. At the user's discretion, commands are executed by pressing buttons or manipulating a digital direction control on the controller. The software runs in the background on the user's system and receives the controller commands.

Using the selections made in the user's installation setup and saved preferences, the controller commands are relayed from the software to the third party system 180, executing the user's desired actions. The installation and setup procedures will likely occur one-time on the user's computer system. The execution and selection of user generate action requests can occur on a frequent basis throughout the day as the controller is employed by the user.

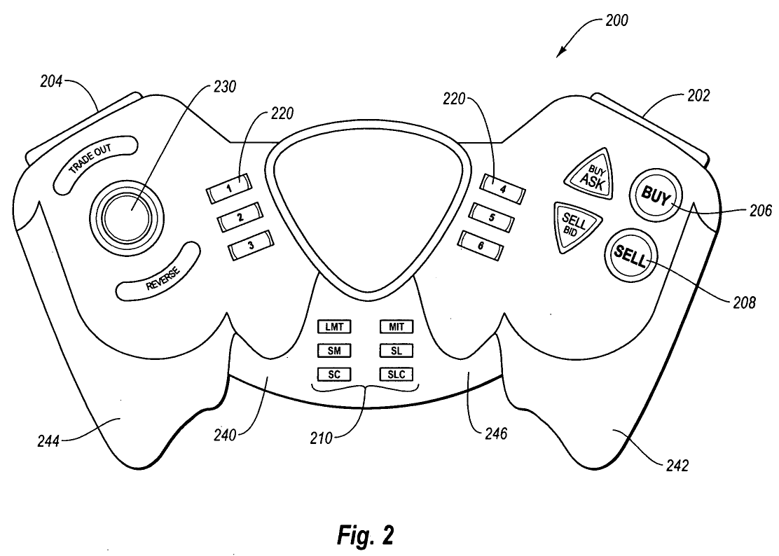

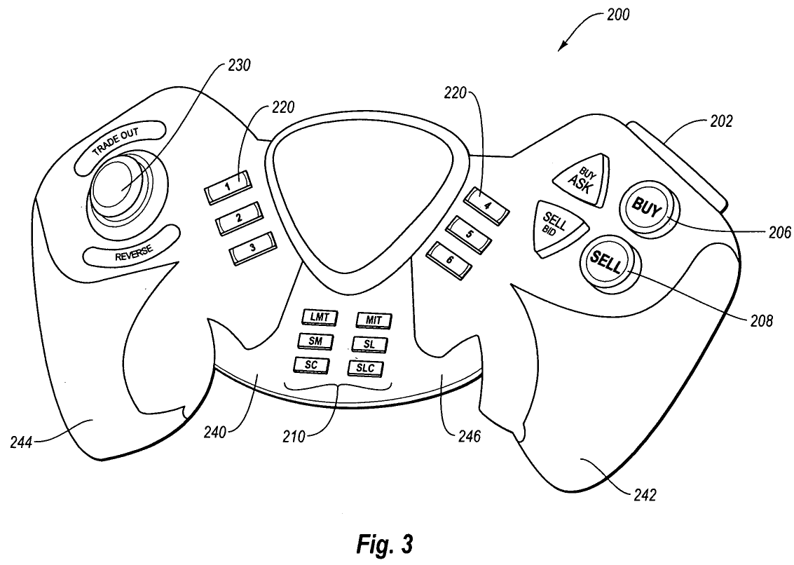

As illustrated in FIGS. 2 and 3, the user executes a command by selecting a button on a controller 200. To prevent accidental or unintentional command execution from the controller 200, a confirmation method is structured within the controller 200 and/or software package. As an example, if the controller 200 is dropped, upon impact a trade order button could be inadvertently pushed without the confirmation method. In this way, the command confirmation can prevent involuntary orders from being transmitted to the third party system 180.

The command confirmation method can be executed by holding down a confirmation button 202, 204 and simultaneously executing a command by pressing the desired command button, such as a buy button 206, sell button 208, or other button including a command, such as a buy ask button, a sell bid button, a market order button, a limit order button, a stop market order button, a stop-limit order button, a stop-loss order button, a scale order button, a market-if-touched order button, a conditional order button, a trade out button, a reverse button, or other button that represents a trading command. The buttons can be marked by a name, abbreviation, symbol and/or picture. These buttons may be located at any point on the controller. For example, the buttons can be located in a position that is easily viewed and actuated by the user's index finger and thumb on one hand. The command confirmation method includes two buttons on the controller 200. One button is pressed simultaneously with another button to confirm the desired action and relay the command through the computer to the third party system 180.

Other buttons may be added to the controller 200 to provide additional functions and features. These buttons can also be defined as command buttons. The other buttons, for example, can include action buttons 210, such as limit order, stop market order, stop-limit order, stop-loss order, scale order, market-if-touched order, conditional order, and other known orders can be configured in the controller 200. A set of portfolio buttons 220 can also be added to the controller 200 to provide quick access to the user's assets in the portfolio. These buttons can be numbered, for instance, to provide access to an asset assigned to the numbered button. When a user presses a numbered button, snapshot view of the asset can be viewed to show the last price, the day's change, bid size, ask size, the day's range, volume, and the like. Other data can also be viewed that includes information such as the open price, previous close price, day's range, 52-week range, average volume, market cap, shares outstanding, beta, dividend yield, declared dividend, expected dividend date, payable dividend date, P/E, EPS, charts, and other information typically used in trading, bidding, or auctioning assets.

The controller 200 can include a joystick 230 to provide cursor movement on a display device. The joystick 230 can also be used to issue a trade out or reverse action request. When the joystick 230 is pressed in first direction, the action can trigger a trade out request. When the joystick 230 is pressed in an opposite or second direction, the action can trigger a reverse request.

The controller 200 can have a modified H-shape configuration with a housing body 240. The housing body 240 can be formed with hand grips 242, 244 at both longitudinal ends to provide support for the user's hands to hold the controller 200. The housing body 240 can include a narrower middle portion 246 to provide a location for user action buttons. The housing body 240 can have a symmetric arrangement to allow the user to manipulate the buttons mainly with the index finger and thumb.

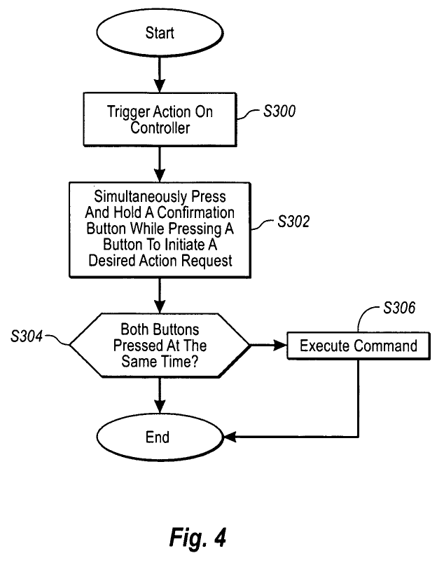

As illustrated in FIG. 4, a method of confirming a user action request is provided through a controller. The user triggers an action on the controller by pressing a button in S300. The user holds the controller to execute a confirmation request. At the user's discretion, the confirmation request is executed by simultaneously pressing and holding a confirmation button while pressing another button to initiate a desired action request in S302. In S304, the software determines whether the buttons were pressed at the same time. If both buttons are not pressed simultaneously, the command is not executed. If the buttons are pressed at the same time, the command is executed in S306. Depending on the user request, some command buttons may require the command confirmation method while other actions do not require the command confirmation method for command execution.

Embodiments of the present invention may include or be conducted using a special purpose or general-purpose computer, processor, or logic device including various computer hardware and devices, as discussed in greater detail herein or known to one of ordinary skill in the art. Embodiments within the scope of the present invention can also include computer-readable media for carrying or having computer-executable instructions or data structures stored thereon. Such computer-readable media can be any available media that can be accessed by a general purpose computer, special purpose computer, or a logic device. By way of example, and not limitation, such computer-readable media can comprise RAM, ROM, EEPROM, CD-ROM or other optical disk storage, magnetic disk storage, other magnetic storage devices, or any other medium which can be used to carry or store desired program code means in the form of computer-executable instructions or data structures and which can be accessed by a general purpose computer, special purpose computer, or other logic devices.

When information is transferred or provided over a network or other communication connection (either hardwired, wireless, or a combination of hardwired or wireless) to a computer, the computer can properly view the connection as a computer-readable medium. Thus, any such connection is properly termed a computer-readable medium. Various combinations of the above should also be included within the scope of computer-readable media. Computer-executable instructions comprise, for example, instructions, logic, and data which cause a general purpose computer, special purpose computer, or logic device to perform a certain function or group of functions.

Each of the processors described herein can be a single conventional general purpose computer, special purpose computer, or logic device, or each processor can be multiple processors including multiple conventional general purpose computer, special purpose computers, or multiple logic devices. Moreover, many of the functions that take place using a processor can be implemented on other types of logic devices, such as programmable logic devices. In addition, additional processors, logic devices, or hardware may be implemented to carry out a given function or step according to additional embodiments of the present invention. For example, additional processors may be implemented for storage and retrieval of data as is known to one of ordinary skill in the art. Such details have been eliminated so as to not obscure the invention by detail.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Accordingly, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system for confirming a user action request, comprising:
a computer system having a user interface connected to the computer system to provide additional user input to the computer system and a display device to display a user interface for software programs; and
a controller attached to the computer system through a connecting device, the controller being configured to relay user action requests through the computer system to a third party system, the controller including a command button and a confirmation button, the confirmation button being pressed simultaneously with the command button to confirm a desired user action request and relay the request through the computer system to the third party system.

2. The system as recited in claim 1, wherein the computer system is a handheld device and the controller is built into the handheld device.

3. The system as recited in claim 1, wherein the third party system is at least one of a broker system, trading platform, an auction system, and a bidding platform.

4. The system as recited in claim 1, wherein the command button includes at least one of a buy button, a sell button, a buy ask button, a sell bid button, a market order button, a limit order button, a stop market order button, a stop-limit order button, a stop-loss order button, a scale order button, a market-if-touched order button, a conditional order button, a trade out button and a reverse button.

5. A controller for confirming a user action request, comprising:
a housing body having a modified H-shape configuration, the housing body having hand grips at longitudinal ends to provide support for the user's hands to hold the controller;
a command button arranged on the housing body, the command button being configured to initiate user action requests to a computer system; and
a confirmation button arranged on the housing body, when the confirmation button is pressed simultaneously with the command button, the user action request is confirmed and relayed through the computer system to a third party system.

6. The controller as recited in claim 5, wherein the housing body further includes a narrower middle portion to provide a location for user action buttons.

7. The controller as recited in claim 6, wherein the user action buttons include at least one of limit order, stop market order, stop-limit order, stop-loss order, scale order, market-if-touched order, and conditional order.

8. The controller as recited in claim 5, wherein the command button includes at least one of a buy button, a sell button, a buy ask button, a sell bid button, a market order button, a limit order button, a stop market order button, a stop-limit order button, a stop-loss order button, a scale order button, a market-if-touched order button, a conditional order button, a trade out button and a reverse button.

9. The controller as recited in claim 5, wherein the command button includes a marking with at least one of a name, abbreviation, symbol and picture.

10. The controller as recited in claim 5, wherein the command button and the confirmation button are located in a position that is easily actuated by the user's index finger and thumb on one hand.

11. The controller as recited in claim 5, further comprising a set of portfolio buttons arranged on the housing body, the portfolio buttons providing quick access to assets in a portfolio.

12. The controller as recited in claim 11, wherein the portfolio buttons are numbered to provide access to an asset assigned to the numbered button.

13. The controller as recited in claim 5, further comprising a joystick to provide cursor movement on a display device.

14. The controller as recited in claim 13, wherein the joystick is actuated by the user to issue a trade out or reverse action request.

15. The controller as recited in claim 13, wherein when the joystick is pressed in first direction, the action triggers a trade out request.

16. The controller as recited in claim 13, wherein when the joystick is pressed in second direction, the action triggers a reverse request.

17. A method of confirming a user action request through a controller connected to a computer system, the method comprising:
triggering an action on the controller by pressing a button;
executing a confirmation request by simultaneously pressing and holding a confirmation button while pressing another button to initiate a desired action request;
determining whether the buttons were pressed at the same time;
if both buttons are not pressed simultaneously, the computer system not executing the command; and
if the buttons are pressed at the same time, the computer system executing the command.

18. The method as recited in claim 17, further comprising holding the controller to execute the confirmation request.

19. The method as recited in claim 17, further comprising when the command is executed, the command is relayed through the computer system to a third party system.

20. The method as recited in claim 19, wherein the third party system is at least one of a broker system, trading platform, an auction system, and a bidding platform.
